(19) United States
(12) Patent Application Publication
(10) Pub. No.: US 2019/0116790 A1
(43) Pub. Date: Apr. 25, 2019

(54) Jinggangmycin and Ipconazole Fungicidal Composition and Applications Thereof

(71) Applicant: NANJING AGRICULTURAL UNIVERSITY, Nanjing (CN)

(72) Inventors: Mingguo ZHOU, Nanjing (CN); Yabing DUAN, Nanjing (CN); Jianxin WANG, Nanjing (CN); Yiping HOU, Nanjing (CN); Ying YANG, Nanjing (CN)

(21) Appl. No.: 16/098,764

(22) PCT Filed: Jun. 6, 2016
(86) PCT No.: PCT/CN2016/084926

§ 371 Date: Nov. 2, 2018

(30) Foreign Application Priority Data
May 10, 2016 (CN) 201610316497.7

(51) Int. Cl. A01N 43/16; A01N 43/653

(52) U.S. Cl. CPC A01N 43/16; A01N 43/653

(57) ABSTRACT

A jinggangmycin and ipconazole fungicidal composition, a weight ratio of jinggangmycin to ipconazole being (1-68):(40-1). The fungicidal composition of the present invention has a remarkable synergistic effect in preventing and controlling fusarium head blight of wheat and barley, powdery mildew of wheat and barley, rust of wheat and barley, sheath blight of wheat and barley, leaf blight of wheat and barley, rice blast, rice false smut and rice sheath blight, particularly the synergistic effect in preventing and controlling fusarium head blight of wheat and barley is more remarkable, and the contamination level of DON toxin in grains can be significantly decreased.

### TECHNICAL FIELD

The present invention relates to a jinggangmycin and ipconazole fungicidal composition and applications thereof, which belong to a pesticide composition with a synergistic and dosage-reducing effect in the technical field of pesticides, and its active components are jinggangmycin and ipconazole.

### BACKGROUND ART

Jinggangmycin, also called validamycin, is a secondary metabolite of actinomycetes, and contains six types of similar amino glucan glycoside derivatives A, B, C, D, E and F. A large number of domestic and foreign studies have shown that the component A is the main active component of jinggangmycin. Therefore, jinggangmycin as a main component related to the present invention is jinggangmycin A. Jinggangmycin shows interference specific to the development of hyphae at the tips of rhizoctonia fungi (Rhizoctonia spp.) among basidiomycetes in vitro. Therefore, since jinggangmycin was discovered in 1970s, jinggangmycin has always served as an agricultural antibiotic for specifically preventing and controlling plant diseases caused by rhizoctonia, or has been processed into mixtures along with pesticides for preventing and controlling other plant pests to control rhizoctonia (Rhizoctonia spp.) diseases. These rhizoctonia diseases mainly include rice sheath blight, wheat sheath blight and sheath blight or damping-off of other crops. In recent years, it has also been discovered that jinggangmycin can also be used for preventing and controlling false smut caused by hard-to-culture imperfect fungi (Ustilaginoidea virens).

Ipconazole is a triazole ergosterol biosynthesis inhibitor, the molecular formula is C₁₈H₂₄ClN₃O, the chemical name is 2-((4-chlorobenzyl)methyl-5-(1-isopropyl)-1-(1H-1,2,4-triazole-1-methyl)cyclopentanol, and the CAS number is 125225-28-7. With systemic, protective and curative activities, ipconazole can effectively prevent and treat diseases caused by ascomycete, basidiomycete and imperfect fungi, and by treating seeds, ipconazole is transmitted from roots to stems and leaves, having a good prevention effect on fusarium head blight, leaf spot and blight.

In the process of crop growth, some diseases will inevitably occur, and if the diseases are not prevented and treated in time, the severe loss of crop yields will be caused. However, the frequent use of the same type of agent in preventing and controlling these diseases often leads to fungicide resistance developed by these diseases. In order to solve these problems, by combining pesticides with different mechanisms of action according to a proportion, not only can the development of fungicide resistance by a pathogenic population be effectively retarded, but also there is a synergistic and dosage-reducing effect on the prevention and control of plant diseases. Jinggangmycin or validamycin only shows specific antifungal activity on rhizoctonia in vitro, and does not have antifungal activity on fusaria resulting in fusarium head blight. Therefore, people have always been researching the selective mechanism of jinggangmycin with rhizoctonia as an object for decades, discovering that validamycin/jinggangmycin interferes with the inositol and trehalose metabolism of rhizoctonia, as a result, the structure of a cell wall is destroyed, rhizoctonia is prevented from infecting plants, and thereby jinggangmycin has a good protective effect. On the basis of researching a DON toxin biosynthesis pathway and regulatory mechanism of fusarium, the inventor carried out the screening of a large number of compounds for inhibiting DON toxin biosynthesis. In the screening process, it was surprisingly discovered that under certain treating dosage, jinggangmycin can strongly inhibit biochemical reaction in the early pathway of DON toxin biosynthesis of wheat scab fungi. Therefore, although jinggangmycin cannot effectively prevent and control fusarium head blight of wheat and barley alone, jinggangmycin has a certain inhibitory effect on the secondary metabolite (DON toxin) of fusaria. The inventor researches the inhibition of the synthesis of the pathogenic factor DON of fusaria by jinggangmycin/validamycin and the screening of synergistic formulas of mixtures of jinggangmycin/validamycin and other various fungicides for preventing and controlling fusarium head blight in fields for the first time in the world, and creatively discovers that the jinggangmycin and ipconazole composition has the advantages of outstanding synergism, DON toxin contamination reduction and great pesticide dosage reduction in preventing and controlling fusarium head blight of wheat and barley crops. Through an experiment, the inventor also discovers that the present invention also has a remarkable synergistic effect in preventing and controlling rice diseases, such as rice blast, rice false smut and rice sheath blight, and can effectively retard the development of fungicide resistance, reduce the dosage and application frequency of pesticides and reduce the cost of prevention and control.

### SUMMARY OF THE INVENTION

### Objective of the Invention

An objective of the present invention is to provide a jinggangmycin and ipconazole fungicidal composition for preventing and controlling fusarium head blight of wheat and barley and reducing DON toxin contamination in grain. Another objective of the present invention is to provide applications of the fungicidal composition in preventing and controlling rice blast, rice false smut, rice sheath blight and fungal diseases of wheat and barley.

### Technical Solution

In order to achieve the above-mentioned objectives of the present invention, the present invention provides a jinggangmycin and ipconazole fungicidal composition, wherein the weight ratio of jinggangmycin to ipconazole is 1:68 to 40:1.

According to a preferred embodiment of the present invention, the weight ratio of jinggangmycin to ipconazole is 1:34 to 20:1.

According to another preferred embodiment of the present invention, the weight ratio of jinggangmycin to ipconazole is 1:17 to 10:1.

In the jinggangmycin and ipconazole fungicidal composition provided by the present invention, the percentage by weight of jinggangmycin and ipconazole is 2 to 80 percent of the total content of the fungicidal composition, and the rest is a carrier and/or adjuvant acceptable in pesticides.

According to a preferred embodiment of the present invention, the percentage by weight of jinggangmycin and ipconazole is 10 to 70 percent of the total content of the fungicidal composition, and the rest is a carrier and/or adjuvant acceptable in pesticides.

According to another preferred embodiment of the present invention, a fungicidal composition preparation is wettable powder, a suspending agent, microemulsion or a water-dispersible granule.

According to another preferred embodiment of the present invention, the carrier is one or more of water, kaolin, diatomite, attapulgite and light calcium carbonate.

According to another preferred embodiment of the present invention, the adjuvant is one or more of ethanol, methanol, ethylene glycol, propylene glycol, NNO-1, NNO-7, xanthan gum, polyethylene glycol, glycerol, nekal, sodium dodecyl sulfate, sodium dodecyl benzene sulfonate, ammonium sulfate, polyoxyethylene alkyl phenol ether, polyoxyethylene lauryl ether, phenethyl phenol formaldehyde resin polyoxyethyl ether, polyoxyethylene alkyl phenol ether phosphate, polyoxyethylene fatty acid, sulfonic acid polyformaldehyde condensate, N-methylpyrrolidone, calcium alkylbenzene sulfonate, sodium butylnaphthalene sulfonate, benzoic acid, sodium lignin sulfonate, carboxymethyl cellulose, a silicone compound, magnesium aluminium silicate or polyvinyl alcohol.

According to another preferred embodiment of the present invention, disclosed is an application of the fungicidal composition in preventing and controlling fusarium head blight of wheat and barley, sheath blight of wheat and barley, powdery mildew of wheat and barley, rust of wheat and barley and leaf blight of wheat and barley.

According to another preferred embodiment of the present invention, disclosed is an application of the fungicidal composition in preventing and controlling rice blast, rice false smut and rice sheath blight.

Beneficial Effects:

By researching the occurrence of plant diseases, the application techniques of prevention and control agents, the mechanisms of action and fungicide resistance, the inventor provides a theoretical and technical basis for the present invention. By utilizing jinggangmycin and ipconazole for compounding and screening, the present invention is intended to achieve a synergistic formula, reduce pesticide dosage and application frequency, reduce production cost, increase the prevention effect and treat fungicide resistance.

Through indoor and field efficacy experiments of the present invention, the results indicate that jinggangmycin and ipconazole are compatible in physicochemical properties and safe to use and have remarkable efficacy. Compared with other pesticides, the jinggangmycin and ipconazole fungicidal composition has the following advantages:
1. The fungicidal spectrum of the fungicidal composition of the present invention is broad, and by combining jinggangmycin and ipconazole, applicable targets are broadened. The jinggangmycin and ipconazole fungicidal composition can effectively prevent and control not only fusarium head blight, powdery mildew, rust, sheath blight and leaf blight of wheat and barley, but also rice blast, rice false smut and rice sheath blight, reducing the harm of the diseases on crop production and increasing the yield and quality of agricultural products.
2. With a remarkable prevention and control effect, the fungicidal composition of the present invention has a remarkable synergistic effect in preventing and controlling fusarium head blight, powdery mildew, rust, sheath blight and leaf blight of wheat and barley, rice blast, rice false smut and rice sheath blight, reduces pesticide dosage, reduces pesticide application cost, and increases social, economic and ecological benefits.

3. Jinggangmycin and ipconazole in the fungicidal composition of the present invention are fungicides with different mechanisms of action, and do not have cross-resistance with carbendazim as a mainstream agent for preventing and controlling fusarium head blight of wheat and barley in the past. More importantly, the fungicidal composition can reduce DON toxin contamination in grain, decreasing the risk brought to the safety of human grain and food by toxin contamination.

4. Belonging to a compounded pesticide, the fungicidal composition of the present invention has the advantages of compatibility, high effectiveness, low toxicity, low residue, good fast-acting property, long persistence, environment-friendliness, etc.

As a biological and chemical pesticide compound composition, the fungicidal composition can decrease the risk level of fungicide resistance of pathogenic fungi to chemical agents, can help keep pathogenic fungus sensitivity, and can also retard the fungicide resistance of pathogenic fungi to single agents in a formula.

### DETAILED DESCRIPTION OF THE INVENTION

The present invention will be further described below through specific embodiments, but the present invention is not limited by the following embodiments. Each component is added in parts by weight.

### Embodiment 1: 16 Percent of Jinggangmycin-Ipconazole Wettable Powder

Jinggangmycin is 8 percent, ipconazole is 8 percent, NNO-1 is 1 percent, nekal is 3 percent, sodium dodecyl benzene sulfonate is 2 percent, attapulgite is 30 percent, and the rest is light calcium carbonate which is added to 100 percent. The above components are sufficiently and uniformly mixed and ground by a sand mill and pass through a 300-mesh screen, so that 16 percent of jinggangmycin-ipconazole wettable powder is obtained.

### Embodiment 2: 60 Percent of Jinggangmycin-Ipconazole Wettable Powder

Jinggangmycin is 40 percent, ipconazole is 20 percent, NNO-1 is 1 percent, nekal is 3 percent, sodium dodecyl benzene sulfonate is 2 percent, attapulgite is 30 percent, and the rest is light calcium carbonate which is added to 100 percent. The above components are uniformly mixed and ground by a sand mill and pass through a 300-mesh screen, so that 60 percent of jinggangmycin⋅ipconazole wettable powder is obtained.

### Embodiment 3: 42 Percent of Jinggangmycin-Ipconazole Wettable Powder

Jinggangmycin is 30 percent, ipconazole is 12 percent, NNO-1 is 1 percent, nekal is 3 percent, sodium dodecyl benzene sulfonate is 2 percent, attapulgite is 30 percent, and the rest is light calcium carbonate which is added to 100 percent. The above components are uniformly mixed and ground by a sand mill and pass through a 300-mesh screen, so that 42 percent of jinggangmycin⋅ipconazole wettable powder is obtained.

### Embodiment 4: 10 Percent of Jinggangmycin-Ipconazole Suspending Agent

Jinggangmycin is 4 percent, ipconazole is 6 percent, ethylene glycol is 4 percent, propylene glycol is 4 percent, NNO-1 is 1 percent, a dispersing agent NNO-7 is 1 percent, a xanthan gum binder is 0.5 percent, polyethylene glycol is 1 percent, and the rest is water which is added to 100 percent. The above components are sufficiently and uniformly mixed and ground by a sand mill until the diameter of 90 percent of agent particles is less than or equal to 5 μm, so that 10 percent of jinggangmycin-ipconazole suspending agent is obtained.

### Embodiment 5: 48 Percent of Jinggangmycin-Ipconazole Suspending Agent

Jinggangmycin is 36 percent, ipconazole is 12 percent, ethylene glycol is 4 percent, propylene glycol is 4 percent, NNO-1 is 1 percent, a dispersing agent NNO-7 is 1 percent, a xanthan gum binder is 0.5 percent, polyethylene glycol is 1 percent, and the rest is water which is added to 100 percent. The above components are sufficiently and uniformly mixed and ground by a sand mill until the diameter of 90 percent of agent particles is less than or equal to 5 μm, so that 48 percent of jinggangmycin-ipconazole suspending agent is obtained.

### Embodiment 6: 24 Percent of Jinggangmycin-Ipconazole Micro-Suspending Agent

Jinggangmycin is 4 percent, ipconazole is 20 percent, N-methylpyrrolidone is 1 percent, calcium alkylbenzene sulfonate is 2 percent, phenethyl phenol formaldehyde resin polyoxyethyl ether is 2 percent, ethylene glycol is 1.5 percent, a silicone compound is 0.8 percent, xanthan gum is 1 percent, magnesium aluminium silicate is 1 percent, and the rest is water which is added to 100 percent.

Jinggangmycin, ipconazole, N-methylpyrrolidone (solvent), calcium alkylbenzene sulfonate (emulsifier) and phenethyl phenol formaldehyde resin polyoxyethyl ether are added together according to the above proportion and dissolved into a uniform oil phase; and water, ethylene glycol (antifreezing agent), xanthan gum (thickening agent) and the silicone compound (defoaming agent) are together mixed into a uniform water phase. Under high-speed stirring, the water phase is added into the oil phase, and thereby 24 percent of jinggangmycin-ipconazole micro-suspending agent is prepared.

### Embodiment 7: 20 Percent of Jinggangmycin-Ipconazole Water-Dispersible Granule

Jinggangmycin is 4 percent, ipconazole is 16 percent, ammonium sulfate is 10 percent, polyoxyethylene alkyl phenol ether is 2.5 percent, sodium dodecyl benzene sulfonate is 2.5 percent, polyoxyethylene fatty acid is 3.5 percent, and the rest is light calcium carbonate which is added to 100 percent. The above components are sufficiently and uniformly mixed and ground, so that master powder is prepared, the master powder and an appropriate amount of aqueous solution are uniformly mixed, the mixture is sheared at high speed, ground by a sand mill and pelletized by a fluidized bed, and after drying and screening, 20 percent of jinggangmycin-ipconazole water-dispersible granule is prepared.

### Embodiment 8: 30 Percent of Jinggangmycin-Ipconazole Water-Dispersible Granule

Jinggangmycin is 10 percent, ipconazole is 20 percent, ammonium sulfate is 10 percent, polyoxyethylene alkyl phenol ether is 2.5 percent, sodium dodecyl benzene sulfonate is 2.5 percent, polyoxyethylene fatty acid is 3.5 percent, and the rest is light calcium carbonate which is added to 100 percent. The above components are sufficiently and uniformly mixed and ground, so that master powder is prepared, the master powder and an appropriate amount of aqueous solution are uniformly mixed, the mixture is sheared at high speed, ground by a sand mill and pelletized by a fluidized bed, and after drying and screening, 30 percent of jinggangmycin-ipconazole water-dispersible granule is prepared.

### Experimental Example 1: Influence of Jinggangmycin on Inhibition Effect of Ipconazole on Growth of Fusarium Hyphae In Vitro

The present invention adopts a conventional method of fungicide bioassay, jinggangmycin and ipconazole are respectively prepared into 2 mg/mL of mother solution by using sterile water and methanol, a control agent, raw carbendazim, is dissolved into 0.1M/L of hydrochloric acid solution, phenamacril is dissolved in methanol, and thereby 2 mg/mL of mother solution is prepared. When potato dextrose agar media (PDA) are cooled until temperature is about 45° C., jinggangmycin and ipconazole are respectively added in to designed concentrations (see Table 1), and are then poured into culture dishes to produce plates treated by the different agents, the process is repeated after three dishes are treated, hyphal clumps of wild sensitive strains (sensitive strains for short) and carbendazim-resistant and phenamacril-resistant strains (fungicide-resistant strains for short) of common fusarium graminearum and fusarium asiaticum causing fusarium head blight of wheat and barley are inoculated, and are cultured under the temperature of 25° C. for four days, the diameters of the fungal colonies are measured by a crossing method, effective medium dosages (EC₅₀) when different treatments inhibit the growth of the pathogenic fungi by 50 percent are calculated, and antifungal activities are compared.

The experimental result indicates that no matter whether jinggangmycin is used alone or mixed with ipconazole, jinggangmycin almost does not have inhibitory activity on the growth of the sensitive strains and fungicide-resistant strains of the two types of fusaria causing fusarium head blight in vitro, and only when the concentration of jinggangmycin is as high as 50 g/mL can jinggangmycin have 6.5 to 7.8 percent of inhibitory effect on the growth of the two types of fusaria. However, ipconazole has a similar strong inhibitory effect on the hyphal growth of the sensitive strains of the two types of fusaria, and the inhibitory effect of 0.1 gμ/mL of ipconazole for treatment on hyphal growth can exceed 50 percent. Jinggangmycin does not have a synergistic effect for ipconazole in inhibiting hyphal growth in vitro (Table 1).

According to growth inhibition rates of the wild sensitive strains and carbendazim-resistant and phenamacril-resistant strains of fusarium asiaticum and fusarium graminearum treated by different doses of ipconazole, an effective medium dosage (EC₅₀) of ipconazole for inhibiting the growth of the different fungicide-sensitive strains is calculated, it is discovered in a result that the sensitivities of the sensitive strains, the carbendazim-resistant strains and the phenamacril-resistant strains to ipconazole are similar, EC₅₀ is 0.89 to 0.11 μg/mL, and an experimental result is listed in Table 2.

With EC₅₀ of the agents as parameters, the activities of the different fungicides in inhibiting the growth of the fusaria are compared, and it is discovered that the activity of ipconazole is about 4.5 times the activity (EC₅₀ is 0.45 μg/mL for both types of fusaria) of carbendazim on the sensitive strains and about 1.5 times the activity (EC₅₀ is 0.165 μg/mL for both types of fusaria) of phenamacril on the sensitive strains. The result indicates that ipconazole has strong activity in inhibiting the growth of the wild sensitive strains and the carbendazim-resistant and phenamacril-resistant fusaria, helping to decrease the contamination level of DON toxin infecting grains and prevent and control fungicide-resistant diseases.

TABLE 1
Influence of Jinggangmycin and Ipconazole on Growth of
Sensitive Strains of Two Types of Fusaria In Vitro

| | | Average Fungal | | Growth | |
|---|---|---|---|---|---|
| Strains | | Colony | | Inhibition | |
| | Concentration | Diameter (mm) | | Rate (%) | |
| Agents | (μg/mL) | F.g* | F.a* | F.g | F.a |
| Jinggangmycin | 0.1 | 76.3 | 76.3 | / | / |
| | 1 | 76.2 | 76.3 | / | / |
| | 10 | 75.4 | 75.6 | / | / |
| | 50 | 70.3 | 69.4 | 6.52 | 7.84 |
| Ipconazole | 0.0125 | 53.5 | 53.1 | 28.86 | 29.48 |
| | 0.025 | 46.4 | 46.2 | 38.30 | 38.65 |
| | 0.05 | 44.5 | 43.9 | 40.82 | 41.70 |
| | 0.1 | 31.8 | 32.1 | 57.71 | 57.37 |
| | 0.2 | 17.2 | 17.6 | 77.13 | 76.63 |
| Jinggangmycin + | 0.1 + 0.05 | 44.6 | 44.1 | 40.69 | 41.43 |
| Ipconazole | 1.0 + 0.05 | 43.2 | 43.4 | 42.55 | 42.36 |
| | 10.0 + 0.05 | 44.1 | 45.6 | 41.36 | 39.44 |
| | 50.0 + 0.05 | 43.9 | 44.4 | 41.62 | 41.04 |
| | 0.1 + 0.1 | 31.2 | 31.6 | 58.51 | 58.03 |
| | 1.0 + 0.1 | 31.9 | 32.2 | 57.58 | 57.24 |
| | 10.0 + 0.1 | 30.9 | 31.7 | 58.91 | 57.90 |
| | 50.0 + 0.1 | 31.2 | 32 | 58.51 | 57.50 |
| Control | 0 | 75.2 | 75.3 | / | / |

*F.g and F.a are abbreviations of Fusarium graminearum and Fusarium asiaticum, similarly hereinafter.

TABLE 2
Inhibitory Activity of Ipconazole on Growth of Sensitive Strains and Carbendazim-
resistant and Phenamacril-resistant Strains of Two types of Fusaria

| | Strains | | | | | |
|---|---|---|---|---|---|---|
| | F.g | F.g | F.g | F.a | F.a | F.a |
| | sensitive | carbendazim- | phenamacril- | sensitive | carbendazim- | phenamacril- |
| | strains | resistant strains | resistant strains | strains | resistant strains | resistant strains |
| EC₅₀ | 0.89 | 0.946 | 0.101 | 0.104 | 0.11 | 0.986 |
| (μg/mL) | | | | | | |

### Experimental Example 2: Inhibitory Activity of Jinggangmycin on Toxin Biosynthesis Capability of Fusaria

As the fungicide sensitivities of fusarium graminearum and fusarium asiaticum to jinggangmycin and ipconazole are the same, the inventor chooses fusarium asiaticum with high toxin synthesis capability (the weight of synthesized DON per unit fungus amount, μgDON/g by dry weight of hyphae) as a material to further research toxin synthesis. Carbendazim-resistant fusarium asiaticum causing fusarium head blight of wheat and barley is inoculated into 3 percent of sterile mung bean soup, the solution is shaken for culture under the temperature of 25° C. and 12/24 hours of scattered light for three days, and conidia are collected centrifugally. The conidia are inoculated into GYEP culture solutions containing different doses of jinggangmycin according to final 10²/mL and shaken to be cultured under the temperature of 25° C. and in the dark, cultures are filtered after seven days and fourteen days, toxin contents in the culture solutions are assayed respectively and the dry weights of hyphae are measured, and toxin synthesis capabilities (the amount of toxin produced per unit weight of hyphae) are analyzed.

Toxin Determination Method: The culture filtrate is respectively extracted with ethyl acetate by equal volume twice, extraction liquids are vacuum-distilled and dried after being combined, an extract is dissolved by 1 mL of acetonitrile and transferred into a new centrifuge tube, a solution is distilled and dried again, and stored under −20° C. for later assay. During assay, 100 μL of TMS derivatization reagent (TMSI:TMCS=100:1) is added, 1 mL of ultrapure water is added after 10 minutes of uniform mixing, supernate is extracted and added into a GC sample bottle after shaking for layering, and a gas chromatograph (GC-ECD) with an electron capture detector is used to carry out toxin content assay. With a DON reagent of Sigma as a standard sample, a standard curve is created, and DON contents, including DON, 3ADON and 15ADON, in the culture solutions are calculated. Meanwhile, the filtered hyphae are dried to constant weights under 80° C., and the dry weights of the hyphae are measured. In addition, after three days of shaking for culture, the hyphae are taken out, and the expression levels of the key gene Tri5 for toxin synthesis are assayed.

It is discovered from an experimental result (Table 3) that the hyphal growths of the fusarium head blight fungi increase as culture time extends, but, after shaking for culture in the media treated by the different doses of jinggangmycin, hyphal growths are not notably changed in comparison with that of the blank control. It is indicated that jinggangmycin does not have the inhibitory effect on the growth of the fusarium head blight fungi cultured in liquid, which is the same as a linear growth rate determination result on the PDA plates. However, it is discovered for the first time that the amount (μg DON/g by dry weight of hyphae) of DON toxin synthesized per unit hyphal weight is remarkably decreased as the treating dosage of jinggangmycin is increased. Moreover, the inhibitory effect of jinggangmycin on DON synthesis decreases as culture time extends, and especially, the decreasing amplitude of low-concentration treatment is greater. It is indicated that jinggangmycin may be degraded as experimental time extends, and as a result, the inhibitory effect on toxin biosynthesis may be decreased.

According to toxin synthesis gene expression level analysis on the third day of treatment, it is creatively discovered that although jinggangmycin does not have adverse influence on the growth and hyphal morphology of fusaria in vitro, a very low treating dose of jinggangmycin can strongly inhibit the expression of the key gene tri5 for DON toxin synthesis, weakening the toxin biosynthesis capability of thalli and reducing DON biosynthesis, and an experimental result is listed in Table 4.

TABLE 3
Effect of Jinggangmycin in Inhibiting DON
Toxin Synthesis Capability of Fusaria

| | Toxin Production | | | |
|---|---|---|---|---|
| | Capability of Hyphae | | | |
| Treating Dosage of | (μgDON/g by dry | | DON Biosynthesis | |
| Jinggangmycin | weight of hyphae) | | Inhibition Rate (%) | |
| (μg/ml) | 7 d | 14 d | 7 d | 14 d |
| 0 | 88.0 | 52.32 | / | / |
| 1 | 62.82 | 51.43 | 28.61 | 1.70 |
| 10 | 56.76 | 48.20 | 35.50 | 7.87 |
| 100 | 48.23 | 36.68 | 45.19 | 29.89 |
| 1000 | 30.35 | 22.52 | 65.51 | 56.96 |
| 10000 | 21.23 | 12.85 | 75.88 | 75.44 |

TABLE 4
Influence of Jinggangmycin on Gene Expression
of DON Synthesis Gene Tri5 of Fusaria

| | Relative | Rate of Inhibition |
|---|---|---|
| Treating Dosage of | Expression Level | on Relative Expression |
| Jinggangmycin (μg/ml) | of Tri5 Gene | Level of Tri5 Gene (%) |
| 0 | 1 | / |
| 1 | 0.41 | 59 |
| 10 | 0.34 | 66 |
| 100 | 0.16 | 84 |
| 1000 | 0.13 | 87 |
| 10000 | 0.10 | 90 |

### Experimental Example 3: Synergistic Effect of Ipconazole for Jinggangmycin in Inhibiting DON Toxin Biosynthesis Capability of Fusaria

Ipconazole treatment can destroy the cell membrane permeability of the fusarium head blight fungi, inhibiting the growth of hyphae. Ipconazole and jinggangmycin composition treatment can enhance the absorption and utilization of jinggangmycin by the pathogenic fungi. While the inhibition of jinggangmycin on DON toxin biosynthesis of the fusaria is determined in experimental example 2, inhibitory effects of jinggangmycin on the DON toxin biosynthesis capability of fusarium asiaticum under the existence of 0.1 μg/mL of ipconazole are determined on the seventh day and the fourteenth day of culture, and the synergistic effect of ipconazole for jinggangmycin in inhibiting DON toxin biosynthesis is analyzed. The DON assay method is the same as that in experimental example 2.

It has been known from experimental example 1 and experimental example 2 that 0.1 μg/ml of ipconazole for treatment alone has an inhibition rate higher than 50 percent on the hyphal growth of the fusarium head blight fungi. It can be seen from the result in Table 5 that 0.1 μg/ml of ipconazole does not have significant inhibitory effects on the toxin biosynthesis capability of the fusaria in comparison with the toxin biosynthesis capability of the blank control on the seventh day and the fourteenth day of treatment, which indicates that ipconazole only has hyphal growth inhibition activity, having no inhibitory effect on toxin synthesis capability. Nevertheless, when 0.1 μg/ml of ipconazole exists in each treatment concentration, the inhibitory effect of jinggangmycin on DON toxin biosynthesis capability is greatly enhanced. Moreover, as culture time extends, the decreasing speed of the inhibitory effect of jinggangmycin on toxin synthesis capability is remarkably lower than that of control treatment without ipconazole, and in particular, the synergistic effect for low-concentration jinggangmycin treatment and the prolonging of action time are more obvious. Based on the results of the simultaneous experiments in Table 3, synergistic effects for jinggangmycin in inhibiting the toxin biosynthesis of the fusaria on the seventh day and the fourteenth day of treatment under the existence of 0.10 μg/mL of ipconazole are calculated, and results are listed in Table 5. These results indicate: (1) jinggangmycin has an effect of strongly decreasing the DON toxin biosynthesis capability of the fusaria, while ipconazole does not have this effect; (2) ipconazole has an obvious synergistic effect for jinggangmycin in inhibiting the toxin biosynthesis of the fusaria, and as the treating dosage of jinggangmycin is reduced, the synergistic effect is enhanced; (3) ipconazole can prolong the time of the inhibitory effect of jinggangmycin on the toxin synthesis of the fusaria, and the synergistic effect is enhanced as the time of treatment extends.

TABLE 5
Synergistic Effect of 0.1 μg/mL of Ipconazole for Jinggangmycin
in Inhibiting DON Toxin Synthesis of Wheat Scab Fungi

| | Toxin | | | | Synergistic | |
|---|---|---|---|---|---|---|
| | Production | | | | Coefficient of | |
| | Capability | | DON | | 0.1 μg/ml of | |
| Treating | (μgDON/ | | Biosynthesis | | Ipconazole for | |
| Dosage of | g by dry | | Inhibition | | inggangmycin in | |
| Jinggangmycin + | weight of | | Rate | | Inhibiting DON | |
| Ipconazole | hyphae) | | (%) | | Synthesis* | |
| (μg/ml) | 7 d | 14 d | 7 d | 14 d | 7 d | 14 d |
| 0 + 0 | 88 | 52.32 | / | / | / | / |
| 0 + 0.1 | 87.68 | 52.16 | 0.36 | 0.31 | / | / |
| 1 + 0.1 | 46.51 | 43.54 | 47.15 | 16.78 | 164.77 | 986.52 |
| 10 + 0.1 | 29.54 | 26.41 | 66.43 | 49.52 | 187.13 | 628.88 |
| 100 + 0.1 | 16.21 | 11.03 | 81.58 | 78.92 | 180.51 | 264.00 |
| 1000 + 0.1 | 8.24 | 4.68 | 90.64 | 91.06 | 138.35 | 159.87 |
| 10000 + 0.1 | 5.61 | 2.89 | 93.63 | 94.48 | 123.39 | 125.23 |

*Synergistic Coefficient Calculation Method: When 0.1 μg/ml of ipconazole exists, an inhibition rate of jinggangmycin on toxin synthesis is divided by a toxin synthesis inhibition rate (Table 3) of a corresponding dose of jinggangmycin for treatment alone, and the result is multiplied by 100.

### Application Embodiment 1: Synergistic Effect and Toxin-Reducing Effect of Jinggangmycin and Ipconazole Composition in Preventing and Controlling Wheat Scab

The field prevention and control efficacy of fungicidal composition preparations of embodiments 1-8 on wheat scab is experimented. The experimental field was arranged in Jiangsu Huai'an White Horse Lake Farm where wheat scab fungi had developed resistance to carbendazim. The wheat variety was Huaimai 22. In November, 2012, sowing was carried out, field management was carried out in a normal way, and other pesticides were not used. On May 2, 2013, i.e., at the initial stage of wheat blooming, a Nongjiale 16 L knapsack electric sprayer was adopted to carry out application for the first time, and according to weather forecast, application was carried out for the second time on May 9 (the initial stage of filling). The area of each plot was 50 square meters, treatment was repeated for four plots, water consumption was 50 kg/Mu, and the fungicidal composition was not applied on the blank control. Meanwhile, 80 g of carbendazim wettable powder which was 50 percent was used as a control agent for treatment per mu. The condition was investigated on May 26, 2013, and the prevention and control effect is shown in table 6. 40 percent of jinggangmycin wettable powder was provided by Zhejiang Tonglu Huifeng Biosciences Co., Ltd., and 40 percent of ipconazole wettable powder was prepared by our lab. According to a corresponding method specified by the industrial standard of Guidelines for the Field Efficacy Trials of Fungicides issued by the Ministry of Agriculture, the occurrence of wheat scab was investigated at the stage of milky ripeness, and according to the actual effect of each treatment in preventing and controlling fusarium head blight, the synergistic effects of the composition were calculated. According to the Abbott (Abbott, 1925) method, a theoretical prevention effect (E=X+(100−X)Y/100, wherein E is theoretical prevention effect, X is the prevention effect of the single jinggangmycin agent, and Y is the prevention effect of the single ipconazole agent) and a synergistic coefficient (actual prevention effect of the composition in application divided by theoretical prevention effect×100) of the composition were calculated. Toxin Determination Method: Two hundred wheat ears were sampled every five treated points at the stage of wax ripeness, and were threshed indoors, and after drying, 30 g of kernels were sampled randomly and ground. According to Goswami and Kistler methods, 5 g of flour was put into a centrifuge tube, 20 mL of extracting solution of acetonitrile and water (84:16) was added into the flour and uniformly mixed by a vortex mixer, the solution was then shaken on a shaker for 24 hours, and was centrifuged at 5000 rpm for 10 minutes, and 2 mL of supernate was blow-dried by nitrogen in an Eppendorf centrifuge tube and preserved under −20° C. During assay, 100 μL of TMS derivatization reagent (TMSI:TMCS=100:1) was added, 1 mL of ultrapure water was added after 10 minutes of uniform mixing, supernate was extracted and added into a GC sample bottle after shaking for layering, a gas chromatograph (GC-ECD) with an electron capture detector was used to carry out toxin content assay, and the result is shown in table 6.

TABLE 6
Synergistic Effect and DON Toxin Contamination-reducing Effect of Jinggangmycin and
Ipconazole Composition in Preventing and Controlling Wheat Scab

| | | | | | | Grain | |
|---|---|---|---|---|---|---|---|
| | | | | | | Toxin | |
| | | | | | | Content | |
| | | | | | | (μg | |
| | | | Disease Index Prevention Effect (%) | | | of | DON |
| | Treating Dosage (g | | Actual | Theoretical | | toxin/g | Contamination |
| | a.i.agent/Mu) | | Prevention | Prevention | Synergistic | of | Reduction |
| Treatment | Jinggangmycin | Ipconazole | Effect | Effect | Coefficient | kernels) | Rate (%) |
| Jinggangmycin | 2 | / | 0 | / | / | 8.91 | 16.18 |
| Jinggangmycin | 4 | / | 8.65 | / | / | 8.61 | 19.00 |
| Jinggangmycin | 8 | / | 10.24 | / | / | 6.62 | 37.72 |
| Jinggangmycin | 10 | / | 14.31 | / | / | 6.21 | 41.58 |
| Jinggangmycin | 12 | / | 16.54 | / | / | 5.21 | 50.99 |
| Jinggangmycin | 16 | / | 18.65 | / | / | 4.85 | 54.37 |
| Ipconazole | / | 4 | 42.65 | / | / | 5.41 | 49.11 |
| Ipconazole | / | 6 | 53.45 | / | / | 4.35 | 59.08 |
| Ipconazole | / | 8 | 67.58 | / | / | 4.12 | 61.24 |
| Ipconazole | / | 10 | 72.41 | / | / | 3.85 | 63.78 |
| Ipconazole | / | 16 | 80.33 | / | / | 3.03 | 71.50 |
| Embodiment 1 | 16 | 16 | 87.54 | 84.00 | 104.22 | 0.65 | 93.89 |
| Embodiment 2 | 8 | 4 | 62.14 | 48.52 | 128.06 | 0.89 | 91.63 |
| Embodiment 3 | 10 | 4 | 68.54 | 50.86 | 134.77 | 0.67 | 93.70 |
| Embodiment 4 | 4 | 6 | 70.26 | 57.48 | 122.24 | 0.94 | 91.16 |
| Embodiment 5 | 12 | 4 | 73.86 | 62.13 | 118.88 | 0.87 | 91.82 |
| Embodiment 6 | 2 | 10 | 82.21 | 72.41 | 113.53 | 0.67 | 93.70 |
| Embodiment 7 | 2 | 8 | 79.84 | 67.58 | 118.14 | 0.95 | 91.06 |
| Embodiment 8 | 4 | 8 | 80.25 | 70.38 | 114.02 | 0.91 | 91.44 |

| | | | | | |
|---|---|---|---|---|---|
| Control Agent: Carbendazim 40 g a.i./Mu | 67.5 | / | / | 4.42 | 58.42 |
| Blank Control Disease Index | 47.2 | / | / | 10.63 | / |

The field screening and experiment results of the synergistic effect of the fungicidal composition for preventing and controlling wheat scab in the present invention indicate that when the jinggangmycin and ipconazole composition is sprayed from the initial stage of wheat blooming to the filling stage, different preparations of embodiments 1-8 each have an outstanding synergistic effect (the synergistic coefficient is greater than 100) on wheat scab under certain dosages. Moreover, after being applied, the jinggangmycin and ipconazole composition has a remarkable synergistic effect in decreasing the DON contamination level of grains, the DON content can be reduced by 90 percent or more, and the DON contamination level can be controlled at a safe level of 1 mg of DON/kg of grain or lower.

### Application Embodiment 2: Experiment Result of Jinggangmycin and Ipconazole Composition in Preventing and Controlling Other Wheat Diseases

The field prevention and control efficacy of the fungicidal composition preparations of embodiments 1-8 on wheat diseases was experimented. The experimental field was arranged in Jiangsu Yancheng Xinyang Farm. The wheat variety was Huaimai 33. At the initial stage of wheat blooming, a Nongjiale 16 L knapsack electric sprayer was adopted to carry out application for the first time, application was carried out for the second time after five days, water consumption was 50 kg/Mu, the area of each plot was 50 square meters, each treatment was repeated for three times, and the fungicidal composition was not applied on the blank control. Meanwhile, 80 g of carbendazim wettable powder which was 50 percent was used as a control agent for treatment per mu. According to a corresponding method specified by the industrial standard of Guidelines for the Field Efficacy Trials of Fungicides issued by the Ministry of Agriculture, the occurrences of powdery mildew, rust, sheath blight and leaf blight of wheat were investigated at the stage of milky ripeness, disease indexes and prevention and control effects were calculated, and the result is shown in table 7.

TABLE 7
Experiment on Field Efficacy of Jinggangmycin and Ipconazole Composition
in Preventing and Controlling Wheat Diseases

| | Treating Dosage | | Disease Index Prevention Effect (%) | | | |
|---|---|---|---|---|---|---|
| | (g a.i.agent/Mu) | | | Powdery | | Sheath |
| Treatment | Jinggangmycin | Ipconazole | Leaf Blight | Mildew | Rust | Blight |
| Embodiment 1 | 16 | 16 | 80.58 | 82.04 | 84.26 | 82.74 |
| Embodiment 2 | 8 | 4 | 81.78 | 75.41 | 80.47 | 76.54 |
| Embodiment 3 | 10 | 4 | 75.95 | 81.49 | 81.20 | 71.3 |
| Embodiment 4 | 4 | 6 | 77.55 | 84.03 | 80.76 | 76.01 |
| Embodiment 5 | 12 | 4 | 81.20 | 75.97 | 79.01 | 80.49 |
| Embodiment 6 | 2 | 10 | 82.36 | 91.49 | 92.65 | 71.36 |
| Embodiment 7 | 2 | 8 | 84.11 | 93.76 | 91.92 | 72.16 |
| Embodiment 8 | 4 | 8 | 81.63 | 94.86 | 97.84 | 69.54 |

| | | | | |
|---|---|---|---|---|
| Control Agent: Carbendazim 40 g a.i./Mu | 48.53 | 52.62 | 61.24 | 44.65 |
| Blank Control Disease Index | 5.21 | 18.53 | 16.89 | 27.54 |

The field application results of embodiments 1-8 indicate that while effectively preventing and controlling wheat scab, the jinggangmycin and ipconazole composition fungicide also has a good prevention and control effect on leaf blight, powdery mildew, rust and sheath blight of wheat, which is far better than that of commonly used carbendazim (The assay showed that pathogenic fungi which showed resistance to carbendazim in pathogenic fungus colonies in the experimental field accounted for 37.7 percent), moreover, the jinggangmycin and ipconazole composition has extremely remarkable synergy and prevention and control effects on fusarium head blight caused by fungicide-resistant fusarium head blight fungi, and the result was similar to the field experiment result in White Horse Lake Farm in the same year. Therefore, the fungicidal composition of the present invention has a lot of advantages, such as little dosage, low cost, environment-friendliness, outstanding social benefit, etc.

### Application Embodiment 3: Prevention and Control Effect of Jinggangmycin and Ipconazole Composition in Preventing and Controlling Barley Diseases and Effect in Reducing Toxin Contamination

The field prevention and control efficacy of the fungicidal composition preparations of embodiments 1-8 on barley diseases was experimented, wherein different doses of single jinggangmycin agent and single ipconazole agent were designed for treatment. In 2014, application was carried out for the first time at the initial stage of barley blooming, application was carried out for the second time after five days, water consumption was 50 kg/Mu, the area of each plot was 50 square meters, each treatment was repeated for three times, and the fungicidal composition was not applied on the blank control. A conventional agent, polyketone wettable powder, was adopted as a control agent. According to a corresponding method specified by the industrial standard of Guidelines for the Field Efficacy Trials of Fungicides issued by the Ministry of Agriculture, the occurrences of barley scab, powdery mildew, rust and leaf blight were investigated at the stage of milky ripeness, disease indexes and prevention and control effects were calculated, and the result is shown in table 8. One hundred and fifty barley ears were sampled randomly every five treated points at the stage of wax ripeness, taken in for threshing and assayed according to the method of application embodiment 1, and toxin contents of the kernels were calculated. The treating dosages, prevention effects and influences of the agents on toxin content are shown in Table 8.

TABLE 8
Effect of Jinggangmycin and Ipconazole Composition in Preventing and Controlling
Barley Diseases

| | | | | | | | Grain Toxin | |
|---|---|---|---|---|---|---|---|---|
| | | | Disease Index Prevention Effect (%) | | | | Content | Toxin |
| | Treating Dosage (g | | Fusarium | | | | (mg of | Reduction |
| | a.i.agent/Mu) | | head | Powdery | | Leaf | DON/Kg of | Percentage |
| Treatment | Jinggangmycin | Ipconazole | blight | Mildew | Rust | Blight | kernel) | (%) |
| Embodiment 1 | 16 | 16 | 90.63 | 96.15 | 91.78 | 74.38 | 0.34 | 96.01 |
| Embodiment 2 | 8 | 4 | 84.84 | 82.65 | 78.28 | 70.41 | 0.58 | 93.20 |
| Embodiment 3 | 10 | 4 | 82.57 | 85.86 | 81.49 | 74.05 | 0.46 | 94.61 |
| Embodiment 4 | 4 | 6 | 81.13 | 81.92 | 82.55 | 69.59 | 0.73 | 91.44 |
| Embodiment 5 | 12 | 4 | 83.38 | 82.94 | 78.57 | 70.74 | 0.66 | 92.26 |
| Embodiment 6 | 2 | 10 | 87.03 | 95.86 | 91.49 | 74.05 | 0.76 | 91.09 |
| Embodiment 7 | 2 | 8 | 86.30 | 91.78 | 87.41 | 69.42 | 0.74 | 91.32 |
| Embodiment 8 | 4 | 8 | 87.84 | 92.36 | 87.99 | 70.08 | 0.71 | 91.68 |

| | | | | | | |
|---|---|---|---|---|---|---|
| Ipconazole 5 g a.i./Mu | 43.84 | 76.24 | 74.25 | 64.29 | 3.54 | 58.50 |
| Ipconazole 10 g a.i./Mu | 62.41 | 85.64 | 82.65 | 75.34 | 2.57 | 69.87 |
| Jinggangmycin 5 g a.i./Mu | 4.54 | 0 | 0 | 0 | 5.28 | 38.10 |
| Jinggangmycin 10 g a.i./Mu | 12.58 | 0 | 0 | 0 | 4.62 | 45.84 |
| Polyketone 30 g a.i./Mu | 67.34 | 74.11 | 73.26 | 62.61 | 5.86 | 31.30 |
| Blank Control Disease Index | 20.49 | 14.37 | 8.56 | 25.34 | 8.53 | / |

The field application of the composition indicates that the treatment by the single ipconazole agent has a good prevention effect on barley scab, leaf blight, powdery mildew and rust while, except having a low prevention effect on fusarium head blight, the single jinggangmycin agent almost has no effect on other diseases. It can be seen from the table that the prevention effect of the fungicidal composition preparations in embodiments 1-8 on fusarium head blight, leaf blight, powdery mildew and rust is greatly enhanced, the prevention and control effect reaches 70 to 90 percent or more, better than the effect of the common control agent, polyketone, and single agents, and the synergistic effect is outstanding. Therefore, the biochemical fungicidal composition of the present invention can greatly reduce the dosage of the chemical fungicide, ipconazole, decrease environment stress caused by pesticides and reduce the toxin contamination of kernels.

### Application Embodiment 4: Experiment Result of Jinggangmycin and Ipconazole Composition in Preventing and Controlling Rice Diseases

The field prevention and control efficacy of the fungicidal composition preparations of embodiments 1-8 on rice diseases was experimented. The experimental field was arranged in Tuqiao Town, Chunhua Street, Jiangning District, Nanjing City, Jiangsu Province. The rice variety was Zhendao 18, the area of each plot was 50 square meters, each treatment was repeated for three times, and the fungicidal composition was not applied on the blank control. At the late stage of rice tillering (top three leaves didn't emerge), application was carried out on rice sheath blight for the first time, application was carried out for the second time at the stage of booting, application was carried out for the third time at the stage of full heading, and 40 percent of single jinggangmycin wettable powder agent produced by Zhejiang Tonglu Huifeng Biosciences Co., Ltd. was adopted as a control agent. Application was carried out on rice false smut for the first time five to seven days before rupturing, application was carried out for the second time at the stage of full heading, and 430 g/L of single tebuconazole suspending agent produced by Bayer Crop science was adopted as a control agent. Application was carried out on rice blast for the first time at the stage of rice rupturing, application was carried out for the second time at the stage of full heading, and 75 percent of single tricyclazole wettable powder agent produced by Jiangsu Fengdeng Crop Protection Co., Ltd. was adopted as a control agent. After the condition became stable, the incidence of disease was investigated, and disease index and prevention effect were calculated.

TABLE 9
Field Experiment Effect of Jinggangmycin and Ipconazole Composition in Preventing
and Controlling Rice Diseases

| | Treating Dosage | | Rice Blast | | Rice False Smut | | Rice Sheath Blight | |
|---|---|---|---|---|---|---|---|---|
| | (g a.i.agent/Mu) | | Disease | Prevention | Diseased Ear | Prevention | Disease | Prevention |
| Treatment | Jinggangmycin | Ipconazole | Index | Effect | Rate % | Effect | Index | Effect |
| Embodiment 1 | 8 | 8 | 1.77 | 74.20 | 0.75 | 79.28 | 1.08 | 82.15 |
| Embodiment 2 | 8 | 4 | 1.55 | 77.41 | 0.69 | 80.94 | 1.34 | 77.85 |
| Embodiment 3 | 10 | 4 | 1.33 | 80.61 | 0.68 | 81.22 | 1.29 | 78.68 |
| Embodiment 4 | 4 | 6 | 1.63 | 76.24 | 0.94 | 74.03 | 1.32 | 78.18 |
| Embodiment 5 | 12 | 4 | 1.43 | 79.15 | 0.84 | 76.80 | 1.44 | 76.20 |
| Embodiment 6 | 2 | 10 | 1.85 | 73.03 | 0.78 | 78.45 | 1.19 | 80.33 |
| Embodiment 7 | 2 | 8 | 1.65 | 75.95 | 0.88 | 75.69 | 1.24 | 79.50 |
| Embodiment 8 | 4 | 8 | 2.01 | 70.70 | 0.91 | 74.86 | 1.52 | 74.88 |
| 75 Percent of Tricyclazole WP 15 g | | | 1.61 | 76.47 | / | / | / | / |
| a.i./Mu | | | | | | | | |
| 430 g/L of Tebuconazole SC 6.5 g | | | / | / | 1.01 | 72.10 | / | / |
| a.i./Mu | | | | | | | | |
| 40 Percent of Jinggangmycin WP 15 g | | | / | / | / | / | 1.76 | 70.91 |
| a.i./Mu | | | | | | | | |
| Blank | / | / | 6.86 | / | 3.62 | / | 6.05 | / |
| Control | | | | | | | | |

The field experiment result indicates that the jinggangmycin and ipconazole composition fungicide has an excellent prevention and control effect in preventing and controlling rice blast, rice false smut and rice sheath blight, and in comparison with mainstream fungicides commonly used at present, the jinggangmycin and ipconazole composition fungicide has an outstanding prevention and control effect. The jinggangmycin and ipconazole composition provided by the invention can simultaneously prevent and control rice blast, rice false smut and rice sheath blight, the prevention effect is increased, moreover, dosage and application frequency are greatly reduced, a great deal of economic investment is saved, and therefore, the present invention is of great practical significance in increasing social, economic and ecological benefits.

What is claimed is:

1. A jinggangmycin and ipconazole fungicidal composition, characterized in that a weight ratio of jinggangmycin to ipconazole is 1:68 to 40:1.

2. The jinggangmycin and ipconazole fungicidal composition according to claim 1, characterized in that the weight ratio of jinggangmycin to ipconazole is 1:34 to 20:1.

3. The jinggangmycin and ipconazole fungicidal composition according to claim 1, characterized in that the weight ratio of jinggangmycin to ipconazole is 1:17 to 10:1.

4. The jinggangmycin and ipconazole fungicidal composition according to claim 1, characterized in that the percentage by weight of jinggangmycin and ipconazole is 2 to 80 percent of the total content of the fungicidal composition, and the rest is a carrier and/or adjuvant acceptable in pesticides.

5. The jinggangmycin and ipconazole fungicidal composition according to claim 4, characterized in that the percentage by weight of jinggangmycin and ipconazole is 10 to 70 percent of the total content of the fungicidal composition, and the rest is a carrier and/or adjuvant acceptable in pesticides.

6. The jinggangmycin and ipconazole fungicidal composition according to claim 1, characterized in that a fungicidal composition preparation is wettable powder, a suspending agent, microemulsion or a water-dispersible granule, the composition is used in a spray.

7. The jinggangmycin and ipconazole fungicidal composition according to claim 4, characterized in that the carrier is one or more of water, kaolin, diatomite, attapulgite or light calcium carbonate.

8. The jinggangmycin and ipconazole fungicidal composition according to claim 4, characterized in that the adjuvant is one or more of ethanol, methanol, ethylene glycol, propylene glycol, NNO-1, NNO-7, xanthan gum, polyethylene glycol, glycerol, nekal, sodium dodecyl sulfate, sodium dodecyl benzene sulfonate, ammonium sulfate, polyoxyethylene alkyl phenol ether, polyoxyethylene lauryl ether, phenethyl phenol formaldehyde resin polyoxyethyl ether, polyoxyethylene alkyl phenol ether phosphate, polyoxyethylene fatty acid, sulfonic acid polyformaldehyde condensate, N-methylpyrrolidone, calcium alkylbenzene sulfonate, sodium butylnaphthalene sulfonate, benzoic acid, sodium lignin sulfonate, carboxymethyl cellulose, a silicone compound, magnesium aluminium silicate or polyvinyl alcohol.

9. An application of the fungicidal composition according to claim 1 in preventing and controlling fusarium head blight of wheat and barley, sheath blight of wheat and barley, powdery mildew of wheat and barley, rust of wheat and barley and leaf blight of wheat and barley.

10. An application of the fungicidal composition according to claim 1 in preventing and controlling rice blast, rice false smut and rice sheath blight.
